(19) United States
(12) Patent Application Publication
(10) Pub. No.: US 2006/0197968 A1
(43) Pub. Date: Sep. 7, 2006

(54) Dicom print driver

(76) Inventor: S. Lance VanNostrand, Plano, TX (US)

Correspondence Address: Pamela R. Crocker;Patent Legal Staff, Eastman Kodak Company, 343 State Street, Rochester, NY, 14650-2201, US

(21) Appl. No.: 11/355,432

(22) Filed: Feb. 16, 2006

Related U.S. Application Data
(60) Provisional application No. 60/657,571, filed on Mar. 1, 2005.

(51) Int. Cl. G06F 3/12

(52) U.S. Cl. 358/1.13

(57) ABSTRACT

A printing system includes a windows printing subsystem including an Application Programming Interface (API), and a printer driver. The printer driver is configured to receive an image from the windows printing subsystem, render the image for printing, and send the rendered image to a Digital Imaging and Communications in Medicine (DICOM) printer for printing.

### CROSS REFERENCE TO RELATED APPLICATIONS

This application claims priority from U.S. Provisional Patent Application Ser. No. 60/657,571 entitled “DICOM WINDOWS PRINT DRIVER”, filed Mar. 1, 2005, which is incorporated herein by reference.

### FIELD OF THE INVENTION

The present invention relates generally to the field of medical printers, and more specifically to a Windows™ driver for printing to Digital Imaging and Communications in Medicine (DICOM) printers.

### BACKGROUND OF THE INVENTION

Health care organizations transfer medical information from one location to another. The medical information can include medical images and medical data. Typically, the printing of medical images and the printing of medical data (i.e., office/consumer type printing) are performed using different protocols. In addition, the medical images and medical data are often printed to different types of printers.

Medical images are intended to be of high quality to provide predictable output for diagnostics purposes. Hospitals typically print medical images in large volumes and desire fast turn-around. As such, many medical image printers are of high printing quality, are capable of printing at high volumes, and therefore are expensive. To ensure high quality printouts and device inter-operability, the Digital Imaging and Communications in Medicine (DICOM) protocol has become an industry standard for medical image printing.

In contrast, office applications do not require diagnostics-quality printouts. Due to the proliferation of the Microsoft Windows Operating System, printer manufacturers targeting office and consumer markets provide printer drivers for various versions of the Windows Operating System. Microsoft implemented the standard printing subsystem and the associated Application Programming Interface (API). Any Windows application can print to any Windows compatible printer, regardless of the manufacturer and model of the printer, by using the standard printing APIs. Although standard, the Windows Printing APIs are different for 9x, NT, Win2K, and XP versions of Windows.

As such, there is a need for a Windows driver to enable printing to a DICOM printer using the standard printing subsystem and the associated printing APIs.

### SUMMARY OF THE INVENTION

One embodiment of the present invention provides a printing system. The printing system includes a windows printing subsystem including an Application Programming Interface (API), and a printer driver. The printer driver is configured to receive an image from the windows printing subsystem, render the image for printing, and send the rendered image to a Digital Imaging and Communications in Medicine (DICOM) printer for printing.

Embodiments of the present invention provide a Windows compatible DICOM print driver. The DICOM printer driver can print both medical images and medical data to a DICOM printer from Windows applications. The DICOM printer driver can print grayscale images up to 16-bits and also perform bilinear and cubic scaling, which are not possible with standard Windows drivers.

### BRIEF DESCRIPTION OF THE DRAWINGS

FIG. 1 is a block diagram illustrating one embodiment of a prior art printing system.

FIG. 2 is a block diagram illustrating one embodiment of a printing system according to the present invention.

FIG. 3 is a table defining the functionality of printing components.

FIG. 4 is a block diagram illustrating another embodiment of a printing system.

FIG. 5 is a block diagram illustrating another embodiment of a printing system.

FIG. 6 is a block diagram illustrating another embodiment of a printing system.

FIG. 7 is a table illustrating one embodiment of a windows print driver (WPD) header structure.

FIG. 8 is a flow diagram illustrating one embodiment of a method for determining the size of an image in grayscale format.

FIG. 9 is a flow diagram illustrating another embodiment of a method for passing grayscale data through the standard Windows printing API.

FIG. 10 is a flow diagram illustrating one embodiment of a method for rescaling an image.

### DETAILED DESCRIPTION OF THE INVENTION

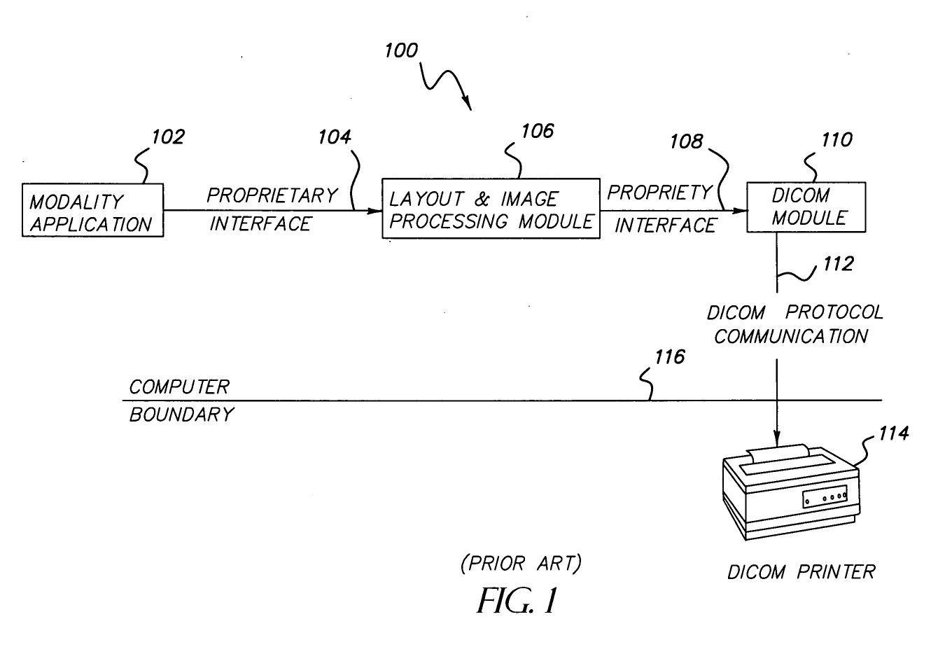

FIG. 1 is a block diagram illustrating one embodiment of a prior art printing system 100. Printing system 100 includes modality application 102, layout and image processing module 106, Digital Imaging and Communications in Medicine (DICOM) module 110, and DICOM printer 114. Modality application 102 is communicatively coupled to layout and image processing module 106 through proprietary interface 104. Layout and image processing module 106 is communicatively coupled to DICOM module 110 through proprietary interface 108. DICOM module 110 is communicatively coupled to DICOM printer 114 through DICOM protocol communication path 112. Modality application 102, layout and image processing module 106, and DICOM module 110 are part of a computer system designated by computer boundary 116. DICOM printer 114 is external to the computer system.

Modality application 102 includes any application, such as a medical analysis, diagnostic, or other suitable medical application that processes and/or generates DICOM data. When modality application 102 prints a DICOM image, modality application 102 passes information relating to the image to layout and image processing module 106 through proprietary interface 104. Layout and image processing module 106 processes the image for printing and generates the layout for the image. Once the image is prepared for printing, layout and image processing module 106 passes the image to DICOM module 110 through proprietary interface 108. DICOM module 110 controls the printing of the image on DICOM printer 114. In one embodiment, DICOM module 110 passes DICOM protocol commands to printer 114 to build each page of the image on printer 114. In another embodiment, DICOM module 110 internally builds each page of the image and passes each completed page to DICOM printer 114 for printing.

Digital Imaging and Communications in Medicine (DICOM) protocol is an industry standard for medical image printing. To support DICOM printers, layered software architecture is known, as indicated at 100. The layered architecture partitions modality application 102, layout and image processing functionality 106, and DICOM layer 110 into independent modules to reduce software development and maintenance costs.

The layered architecture has limitations. The proprietary nature of the architecture forces each vender to develop, test, and certify its own DICOM module 110. Proprietary interface 108 between DICOM module 110 and layout and image processing layer 106 is not standard and may require additional software development by medical equipment manufacturers to support printing protocols other than DICOM. For example, DICOM would be inappropriate for low volume printing applications from a personal computer (PC).

To address these limitations, embodiments of the present invention provide an image printing architecture, referred to as the “Printing Architecture.” The Printing Architecture is built upon the printing subsystem in Microsof™ Windows 2000 and later Operating Systems. The Printing Architecture provides benefits to both medical equipment manufacturers and end users.

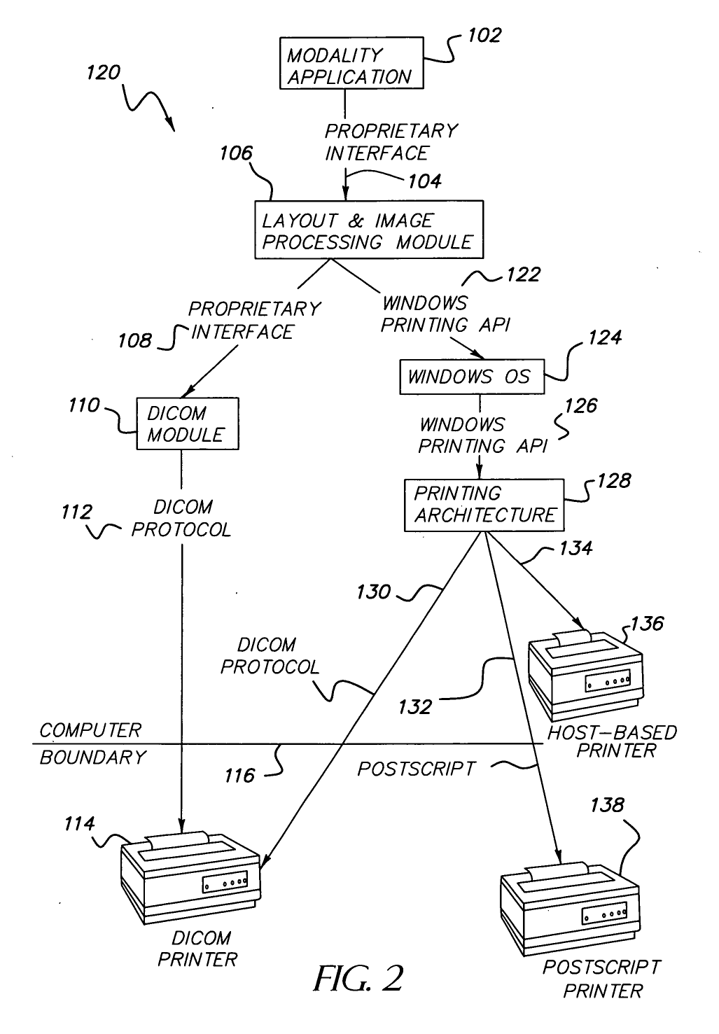

FIG. 2 is a block diagram illustrating one embodiment of a printing system 120 according to the present invention. Printing system 120 includes modality application 102, layout and image processing module 106, DICOM layer 110, Windows Operating System (OS) 124, printing architecture 128, DICOM printer 114, postscript printer 138, and host-based printer 136.

Modality application 102 is communicatively coupled to layout and image processing module 106 through proprietary interface 104. Layout and image processing module 106 is communicatively coupled to DICOM layer 110 through proprietary interface 108 and to Windows OS 124 through Windows Printing Application Programming Interface (API) 122. DICOM layer 110 is communicatively coupled to DICOM printer 114 through DICOM protocol communication path 112 across computer boundary 116. Windows OS 124 is communicatively coupled to printing architecture 128 through Windows Printing API 126. Printing architecture 128 is communicatively coupled to DICOM printer 114 through DICOM protocol communication path 130, postscript printer 138 through postscript communication path 132, and host-based printer 136 through communication path 134.

Modality application 102 is an application such as a medical diagnostic imaging or other medical application that processes and/or generates DICOM data. Layout and image processing module 106 receives image data from modality application 102 through proprietary interface 104 for processing images and generating layouts of images for printing.

DICOM layer 110 receives processed images for printing from layout and image processing module 106 through proprietary interface 108. DICOM layer 110 controls the printing of the image on DICOM printer 114. In one embodiment, DICOM layer 110 passes DICOM protocol commands to printer 114 to build each page of the image on printer 114. In another embodiment, DICOM layer 110 internally builds each page of the image and passes each completed page to DICOM printer 114 for printing.

Windows OS 124 receives processed images for printing from layout and image processing module 106 through Windows Printing API 122 for printing on any suitable type of printer. Printing architecture 128 receives the processed images from Windows OS 124 through Windows Printing API 126 for preparing the images for printing on either DICOM printer 114, postscript printer 138, or host-based printer 136.

The Printing Architecture is based on printing standards established by Microsoft and can be used with all suitable printers. The Printing Architecture is not a proprietary architecture specific to a particular printer. To support a printer or updates to existing printers, medical equipment manufacturers install the new printer driver for the printer. There is no reason to modify or re-test printer communications from modality applications because the print driver includes the software to communicate to the printer.

Due to the proliferation of Microsoft Windows Operating Systems, all printers targeting office and consumer markets provide printer drivers for Windows Operating Systems. Inside each version of the Windows Operating System, Microsoft implemented the Printing Subsystem and the associated Application Programming Interface (API). Any suitable Windows application can print to any suitable Windows-compatible printer by using the standard Windows Printing APIs.

The Windows Printing Subsystem separates user applications from printer drivers. The Windows Printing Subsystem has standard interfaces on both the application and printer driver sides to decouple printer drivers from applications. The decoupling allows applications and printer drivers to be developed separately and verified independently. The decoupling also increases the overall system stability. For example, software defects in a printer driver would prevent user applications from printing to a specific printer, but would not impact any other functionality of the applications. The Printing Architecture, built upon the Windows Operating System, can provide these same benefits.

The Printing Architecture provides a set of customized components and printer drivers to the Windows Printing Subsystem. From the Windows Operating Systems' perspective, the Printing Architecture implements print drivers that follow all standards and guidelines specified by Microsoft. Therefore, the Printing Architecture is compatible with all existing Windows applications that support Windows printing.

The Printer Driver renders pages on the host one at a time, and then sends them to the target printer in the printing protocol supported by the target printer. The Printer Driver maintains the same programming interface to modality applications regardless of the type of the target printer. By adopting the Printing Architecture, modality applications can print to supported printers without any software modification.

To preserve equipment manufacturers' existing printing design, the Printing Architecture 128 coexists and enhances equipment manufacturers' existing printing architecture. Equipment manufacturers can maintain the existing design and implementation of both modality applications 102 and layout and image processing layer 106. Through the standard Windows Printing API, the layout and image processing layer 106 sends the generated image to Printing Architecture 128. Equipment manufacturers have the choice of using either proprietary image processing algorithms, or image-processing algorithms developed and certified by Kodak.

Printing Architecture 128 interfaces to medical printers of various protocols, while presenting the same programming interface to modality applications 102. The equipment manufacturer can therefore concentrate on the development of modality applications 102, instead of connectivity to various medical printers.

To adopt the Printing Architecture, medical equipment manufacturers modify layout and image processing layer 106 in the following areas: (a) Sending the generated bitmap to the Printer Driver, instead of to the DICOM module, through the Windows programming interface; and (b) Querying the Printer Driver, instead of the DICOM module, about the printer status and printer capability. Existing layered printing architectures from medical equipment manufacturers should readily accommodate these changes.

To adopt the Printing Architecture, medical equipment manufacturers have two options regarding user interface changes. The first option includes no change on the typical user interface. Medical equipment manufacturers do not have to modify the modality applications' user interface when adopting the Printing Architecture. By keeping current user interfaces, medical equipment manufacturers can keep the transition to Printing Architectures transparent to the end users as much as possible.

The second option includes minimum changes to follow the standard Windows common look-and-feel. The Printing Architecture supports user interfaces that allow end users to select target printer, printing media, printer settings, etc. These user interface elements follow the Windows common look-and-feel. Equipment manufacturers can adopt these user interface elements whenever appropriate. The Windows common look-and-feel reduces the end users' learning curve and enhances the users' overall experience with modality applications.

Regarding printing to a DICOM Printer from a typical Windows Application, the following two scenarios are discussed to more particularly describe aspects of the present invention: The first scenario includes a Web-based Diagnostics station, a doctor loads a CR image inside the web browser, exams the image, and prints the image to a DICOM printer. The second scenario includes a doctor preparing a diagnostics report using Microsoft Word. Within the report, the doctor inserts a couple of diagnostics images. The doctor then prints the entire report to a DICOM printer.

In each of these two scenarios, the customers have the freedom to use any Windows applications to manipulate medical images and print those medical images in diagnostic quality. The customers do not need to buy two printers, one DICOM printer for medical images and the other for Windows Applications. One printer for both purposes reduces the customer's production and maintenance costs.

Embodiments of the present invention provide for a printer that can be used for both purposes. In general, the DICOM image is sent directly to the printer whereas the non-DICOM image is converted to DICOM prior to being sent to the printer.

To make these two scenarios possible, a Windows printer driver that sends the print job to DICOM printers is used. The printer driver follows all design constraints and guidelines published by Microsoft. The printer driver converts Windows Printing API calls to DICOM protocols and sends the generated DICOM commands to a remote DICOM printer.

Regarding a low cost “dummy” medical printer under Windows, small clinics have limited budgets and printing volumes. Such customers may desire a printer having a lower cost and smaller physical size without sacrificing the printing quality or printing speed. A “dummy” printer can reduce both the cost and physical size. A “dummy” printer refers to a printer that has no, or very few, on-board processing capabilities, connects to the host computer through a parallel, serial, or USB port; and depends on the host computer to control the printing activity.

With the reliability of Windows 2000 and later operating systems, and the performance of Intel x86 compatible CPUs, a PC running Windows 2000 OS or a later operating system is a candidate to control “dummy” medical printers. A printer driver is the software that allows the OS to control the printing process of the connected printers.

A printer driver for dummy medical image printers addresses the following issues: First, many diagnostics quality images are up to 16-bit gray level. Most, if not all, existing printer drivers for commercial office/consumer printers do not support up to 16-bit gray level printing at all. Second, medical images use special rendering algorithms to process the images before printing to physical media. Standard rendering algorithms supported by Windows Operating Systems are fine-tuned toward general business or consumer printing. Therefore, the algorithms are not suitable for medical image printing. Third, the printer driver follows all constraints, guidelines, and programming API specified by the Windows Printing Architecture so that any existing Windows applications can print to the medical image printers without modifications. Fourth, to ensure the inter-operability with other medical imaging equipment, the printer driver supports the DICOM protocol “out-of-the-box.”

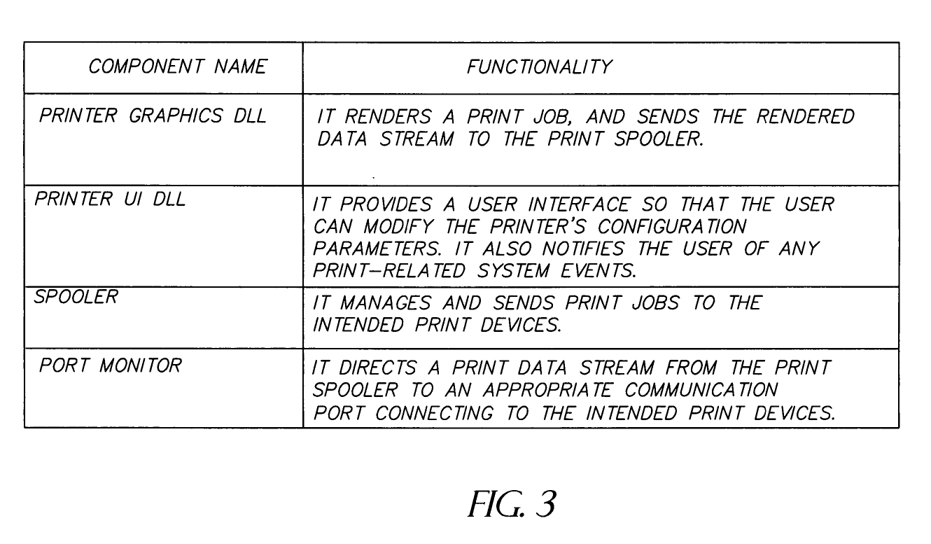

The Windows Printing Subsystem includes the following major components: printer graphics Dynamic Link Library (DLL), printer User Interface (UI) DLL, spooler, and port monitor. In many publications, the printer graphics DLL and printer UI DLL together are referred to as the “printer driver.” The table in FIG. 3 illustrates the finctionality of each component. The printer graphics DLL renders a print job and sends the rendered data stream to the print spooler. The printer UI DLL provides a user interface so that the user can modify the printer's configuration parameters. The printer UI DLL also notifies the user of any print related system events. The spooler manages and sends print jobs to the intended print devices. The port monitor directs a print data stream from the print spooler to an appropriate communication port connecting to the intended print devices.

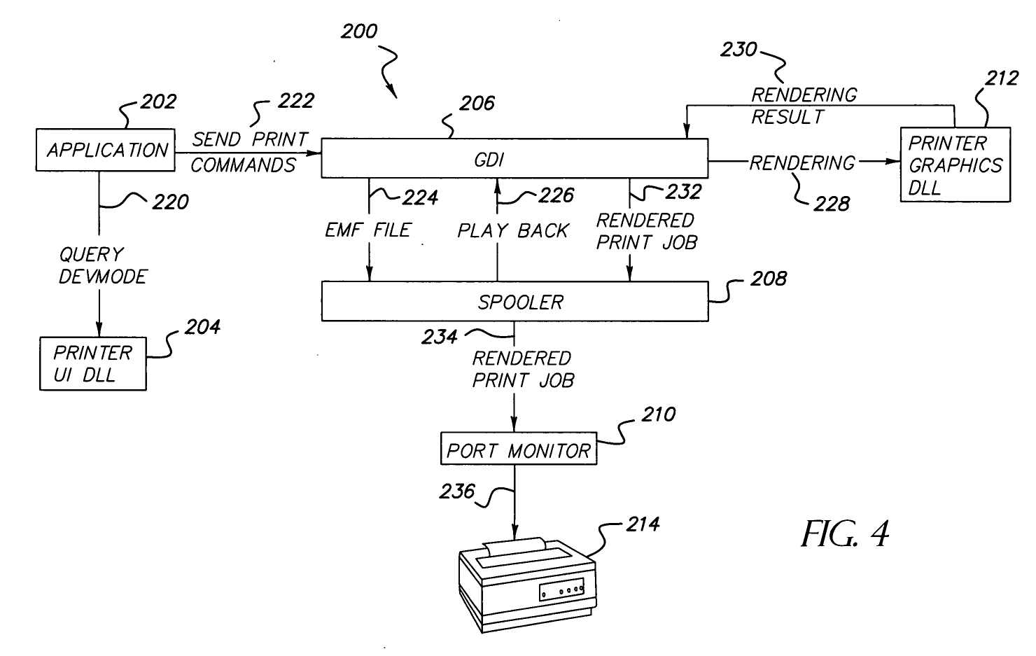

FIG. 4 is a block diagram illustrating another embodiment of a printing system 200. Printing system 200 includes application 202, printer UI DLL 204, Graphics Device Interface (GDI) 206, printer graphics DLL 212, spooler 208, port monitor 210, and printer 214. Application 202 is communicatively coupled to printer UI DLL 204 through query DEVMODE communication path 220. Application 202 is communicatively coupled to GDI 206 through send print commands communication path 222. GDI 206 is communicatively coupled to printer graphics DLL 212 through rendering result communication path 230 and rendering communication path 228. GDI 206 is communicatively coupled to spooler 208 through Enhanced Meta File (EMF) file communication path 224, play back communication path 226, and rendered print job communication path 232. Spooler 208 is communicatively coupled to port monitor 210 through rendered print job communication path 234. Port monitor 210 is communicatively coupled to printer 214 through communication path 236.

Application 202 queries printer UI DLL 204 through query DEVMODE communication path 220 to determine the printer capabilities for determining how to format the document to be printed. DEVMODE is a data structure containing information concerning the environment of a printer. Application 202 then calls the standard Windows Printing API implemented by GDI subsystem 206 in the OS through send print commands communication path 222. GDI 206 is a dynamic link library that processes graphics function calls from a Windows based application and passes them to the appropriate graphics device driver. Spooler subsystem 208 spools the print job in the EMF format through EMF file communication path 224 and “plays back” the spooled print job through play back communication path 226 when the printer is not busy. EMF is a device independent type of spool file that allows control to be returned to the application more quickly after the print request by delaying the rendering of the GDI functions. GDI 206, with the help of the printer graphics DLL 212, renders the print job into a format that the target print device understands. The rendered print job is passed to spooler subsystem 208 through rendered print job communication path 232, and is directed to print device 214 by port monitor 210. Port monitor 210 is a user mode DLL that is responsible for providing a communications path between the user mode print spooler and the printing device.

The spooler subsystem 208 includes one or more print processors. The print processors read the spooled file, perform conversion operations on the data stream and write the converted data to the spooler. The conversion operations controlled by the print processors are the play backs as indicated at 226, the renderings as indicated at 228, the rendering results as indicated at 230, and the rendered print jobs as indicated at 232.

Within each release of the Windows Operating System, Microsoft provides standard components as illustrated in FIG. 4 except printer graphics DLL 212 and printer UI DLL 204. Printer graphics DLL 212 and printer UI DLL 204 are hardware specific. Therefore, each printer manufacturer provides its own printer graphics DLL 212 and printer UI DLL 204. Printer manufacturers can optionally provide customized spooler components 208 and port monitors 210 to enhance the standard functionality provided by the Microsoft components.

The Medical Imaging Printing Architecture in accordance with the present invention provides a set of customized components and printer drivers to the Windows Printing Subsystem. It includes the following major components: print driver; printing processor; and EMF-to-DICOM Converter.

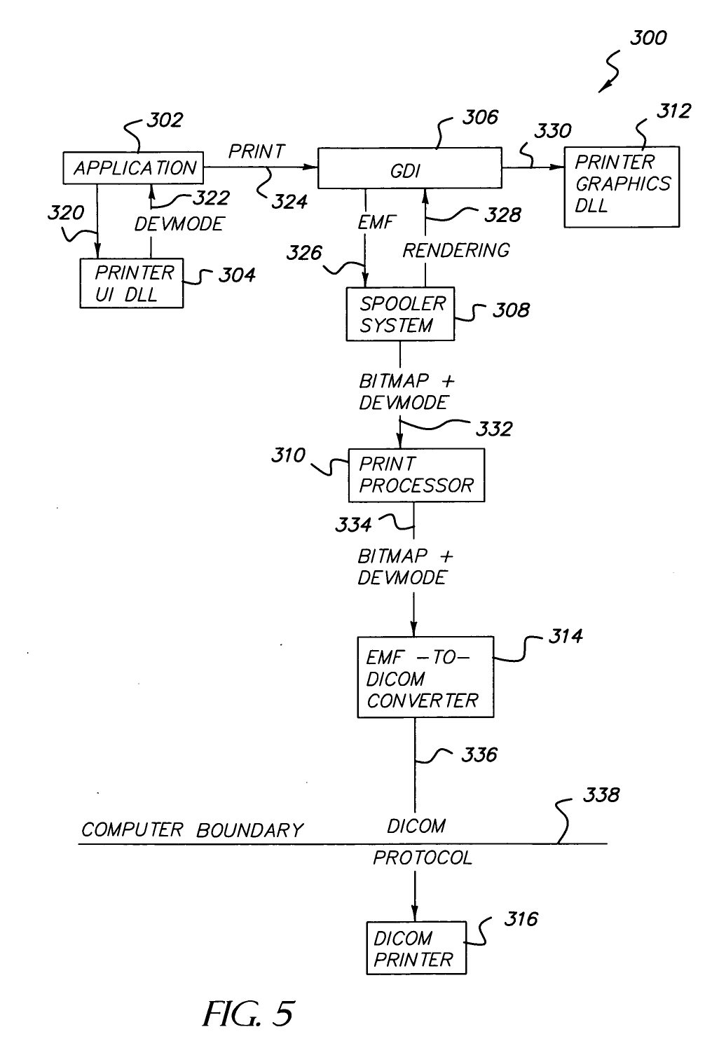

Printing to a DICOM printer from a typical Windows Application is more particularly described with reference to FIG. 5. FIG. 5 is a block diagram illustrating another embodiment of a printing system 300.

Printing system 300 includes application 302, printer UI DLL 304, GDI 306, printer graphics DLL 312, spooler system 308, print processor 310, EMF-to-DICOM converter 314, and DICOM printer 316. Application 302 is communicatively coupled to printer UI DLL 304 through DEVMODE communication path 322 and communication path 320. Application 302 is communicatively coupled to GDI 306 through print communication path 324. GDI 306 is communicatively coupled to printer graphics DLL 312 through communication path 330. GDI 306 is communicatively coupled to spooler system 308 through EMF communication path 326 and rendering communication path 328. Spooler system 308 is communicatively coupled to print processor 310 through bitmap plus DEVMODE communication path 332. Print processor 310 is communicatively coupled to EMF-to-DICOM converter 314 through bitmap plus DEVMODE communication path 334. EMF-to-DICOM converter 314 is communicatively coupled to DICOM printer 316 through DICOM protocol communication path 336 across computer boundary 338.

The printer driver implements both printer graphics DLL 312 and printer UI DLL 304. Printer graphics DLL 312 renders up to 16-bit gray level medical images with rendering algorithms fine-tuned for medical images. The printer driver is also capable of rendering 8-bits per channel RGB medical images for ultrasound applications or reports.

Printer UI DLL 304 maintains the same look-and-feel for the following categories of printers: Dummy medical printers connected to the host PC with parallel, USB, or Firewire. Postscript printers connected to the PC with parallel, USB, Firewire, or Ethernet. Remote DICOM printers connected to the PC with Ethernet. The same look-and-feel greatly reduces the users' training time, therefore enhancing the users' overall experiences with the Medical Image Printing Software.

Print processor 310 co-exists with the standard Microsoft print processors. It has two major functionalities. First, the print processor re-directs print jobs to EMF-to-DICOM converter 314 and sends the generated DICOM commands to a remote DICOM printer 316. Second, the print processor re-directs print jobs to applications that apply “final-touch” to the printing jobs. Kodak Medpage and Print Composer are two examples of such “final touch” applications.

When a Windows application creates a print job using the standard Windows API, the Windows OS collects all the printing commands into a print job file in the Enhanced Metadata Format (EMF). To send the print job to a DICOM printer, EMF-to-DICOM converter 314 converts the printing commands in the EMF file into a sequence of DICOM commands. EMF-to-DICOM converter 314 allows any Windows applications to print to any DICOM printers without any modifications.

The Medical Image Printer Architecture has a modular structure. Various components can “mix-and-match” to support medical image printers of various characteristics. The following description illustrates how the Medical Image Printing Architecture supports the typical scenarios discussed above.

To allow regular Windows applications to print to a DICOM printer, elements needed include printer graphics DLL 312, printer UI DLL 304, print processor 310, and EMF-to-DICOM converter 314 from the Medical Image Printing Architecture.

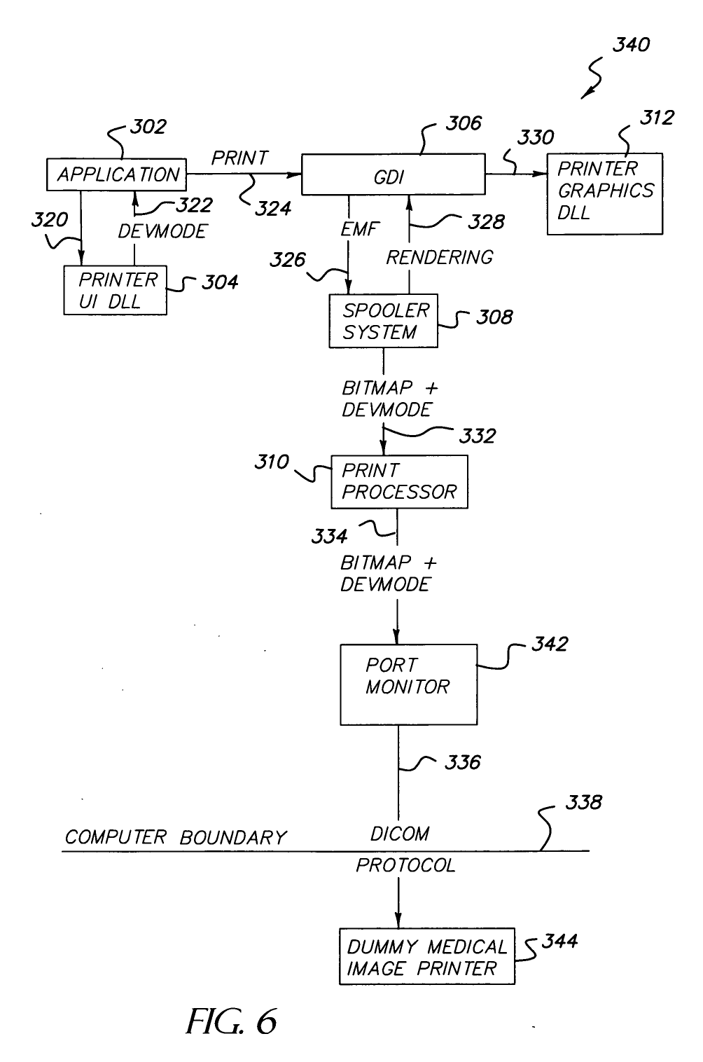

FIG. 6 is a block diagram illustrating another embodiment of a printing system 340. Printing system 340 includes application 302, printer UI DLL 304, GDI 306, printer graphics DLL 312, spooler system 308, print processor 310, port monitor 342, and dummy medical image printer 344. Application 302 is communicatively coupled to printer UI DLL 304 through communication path 320 and DEVMODE communication path 322. Application 302 is communicatively coupled to GDI 306 through print communication path 324. GDI 306 is communicatively coupled to printer graphics DLL 312 through communication path 330. GDI 306 is communicatively coupled to spooler system 308 through EMF communication path 326 and rendering communication path 328. Spooler system 308 is communicatively coupled to print processor 310 through bitmap plus DEVMODE communication path 332. Print processor 310 is communicatively coupled to port monitor 342 through bitmap plus DEVMODE communication path 334. Port monitor 342 is communicatively coupled to dummy medical image printer 344 through DICOM protocol communication path 336 across computer boundary 338.

To control a low-cost, “dummy” medical image printer from a Windows Operating System, elements needed include printer graphics DLL 312, printer UI DLL 304, and print processor 310. In this embodiment, printer graphics DLL 312 renders the entire print job into bitmaps and sends each generated bitmap to dummy printer 344 through port monitor 342. Port monitor 342 allows printer 344 to connect to the host PC through a parallel, USB, USB 2.0, or Firewire port.

The Windows Operating System allows multiple PCs to share the same print device. The “printer sharing” requires no modification at the printer driver level. Therefore, Windows applications running on other PCs can print to the dummy medical image printer through the Windows printer sharing.

To allow other medical equipment to print to dummy printer 344 through the DICOM protocol, a user level application receives the incoming DICOM connections, converting the DICOM print job into a standard Windows print job with Windows printing APIs. A simplified version of MIM is provided by replacing application 302 in FIG. 6 with MIM. The dummy medical image printer will be exposed to other equipment as a fully functional DICOM printer.

Regarding print management software, MedPage is software that allows the user to combine multiple print jobs together into one print job, and apply the following processing to the generated print job before sending it to the print device:

N-up printer—The MedPage can print multiple pages in the original print jobs into one sheet.

Layout modification—The MedPage allows the user to set the position and size of each page in the final printout.

General Image Processing algorithm.

Add header or footer to each sheet in the generated print job.

There are three pixel data spaces defined in medical grayscale imaging including Presentation Value (P-Value), Linear Optical Density (LIN OD), and luminance. The luminance space is the oldest technology in the pixel data representation. Most printing and displaying devices support the luminance space. The P-Value is the most advanced pixel data representation in medical imaging applications. It represents high-quality printing and displaying with the help of extra attributes such as illumination, reflected ambient light, DMin, and DMax. LIN OD can also take advantage of DMin and DMax to improve the image quality in printing and displaying. It is advantageous for a medical imaging application to present the pixel data in P-Value for printing and/or displaying. LIN OD is supported by most printing and displaying devices. P-Value, however, is not supported by all devices.

In grayscale printing, typical Windows applications generate print jobs in the luminance space. Medical imaging applications, however, can generate grayscale images in any one of the three pixel spaces described above. To support the printing of grayscale images in non-standard spaces a high-depth grayscale interface extension to the Windows GDI is provided. The extension provides a mechanism for the application to tell the driver what space the source pixel data is in.

With typical applications, the user has no control of the pixel space when a grayscale print job is submitted. In medical applications, displays and display software may be calibrated for the GSDF (P-values), and/or applications may receive images in raw form from sources that are natively in various image spaces. In these cases, applications will want to pass the data to the driver in its native space (preferred) or in its display space (which may not be luminance). The target printer, however, may not support the native image space. Therefore the windows print driver (WPD) of the present invention provides a UI element for the user to select the target printer pixel space. The selection directs the WPD to convert all data on a page to the target space. The printer image space UI element is applied to grayscale pages and is ignored by color pages. The number of available selections in the UI element varies based on the target printer's capability of supporting pixel spaces.

Medical grayscale images use up to 16 bits per pixel in high resolution and may be printed on large films. Therefore, the size of a medical image may be up to 200 MB. Medical images often require some special rendering. In order to support up to 16-bit grayscale printing, all printers supported by the driver are advertised to Windows as color printers. So all images submitted to the driver are always in 24-bit RGB format. This allows medical grayscale images to pass through the Windows printing channel for special rendering. In general, data in WPD grayscale format cannot be rendered directly. This custom format embeds a header into the pixel data that describes features of the image that cannot be supplied in the Windows GDI functions. In addition, the pixel organization in memory is optimized by allowing 16-bit gray data to be stored in 16 bits, and not forced into a 24-bit Windows format. This saves memory and improves performance.

The WPD grayscale format is the image pixel data format to present medical grayscale images up to 16 bits per pixel to Windows printer drivers in 24-bit RGB format. The data format includes three components including a WPD header, the original grayscale pixel data stream, and a minimal number of padding bytes to make the total data length divisible by three. It is noted that the WPD header can be, for example, 48 bytes (2 RGB pixels) or 64 bytes.

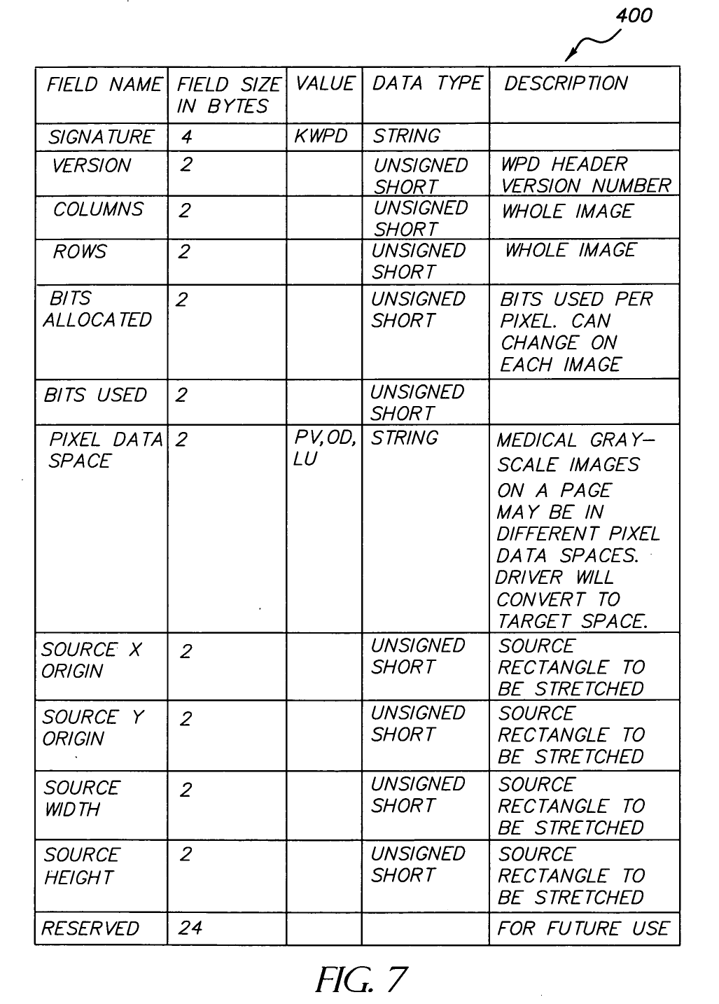

FIG. 7 is a table 400 illustrating one embodiment of a WPD header structure. The remaining space in the header is reserved for expansion. The header clearly identifies the WPD grayscale format with a unique signature and defines the pixel data organization. The header also defines the source rectangle for a specific StretchBlt operation. This definition is updated for every StretchBlt call. The WPD grayscale format can be used for 8-bit and up to 16-bit grayscale images.

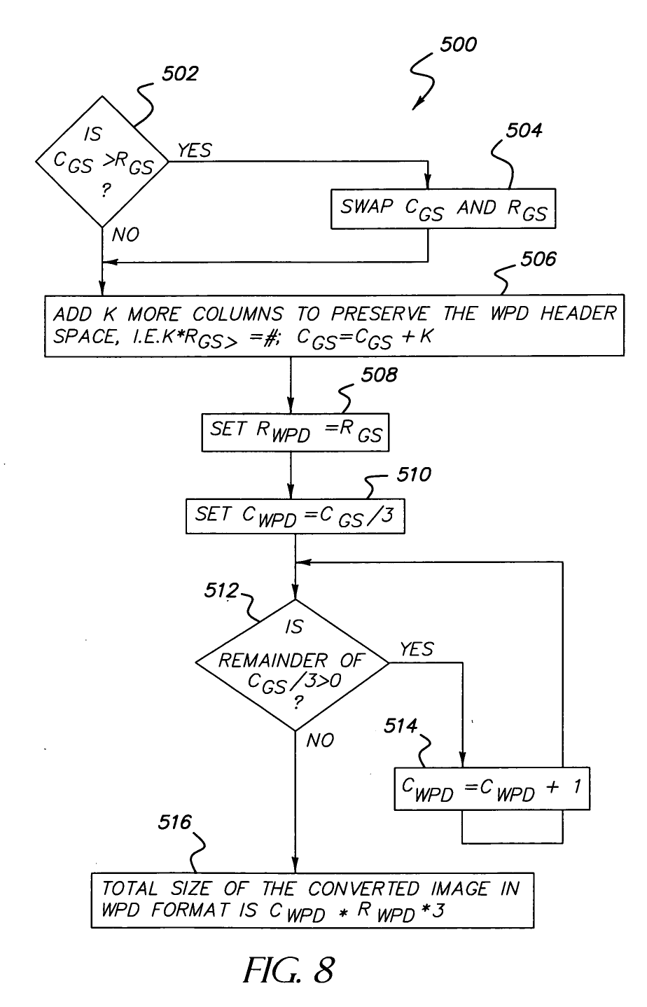

FIG. 8 is a flow diagram 500 illustrating one embodiment of a method for determining the total size of a converted image in WPD format. The size of the image is divisible by three so that the data of this size can be presented to Windows GDI functions as a 24-bit RGB color image. The general idea is to construct an imaginary 24-bit RGB color image of columns by rows by padding data to the original grayscale image of c×r in the direction of longer dimension. For instance, if the image has longer rows than columns, more columns will be padded in the construction.

At 502 it is determined whether the number of columns in the grayscale image (C_{GS}) is greater than the number of rows in the grayscale image (R_{GS}). If the number of columns in the grayscale image is greater than the number of rows in the grayscale image, the number of columns in the grayscale image is swapped with the number of rows in the grayscale image at 504. If the number of columns in the grayscale image is not greater than the number of rows in the grayscale image, or after block 504, at 506, K more columns are added to preserve the WPD header space (i.e., K times the number of rows in the grayscale image is greater than or equal to 64). Therefore, the number of columns in the grayscale image equals the number of columns in the grayscale image plus K.

At 508, the number of rows in the WPD image (R_{WPD}) is set equal to the number of rows in the grayscale image. At 510, the number of columns in the WPD image (C_{WPD}) is set equal to the number of columns in the grayscale image divided by three. At 512, it is determined whether the remainder of the number of columns in the grayscale image divided by three is greater than zero. If the remainder of the number of columns in the grayscale image divided by three is greater than zero, then at 514 the number of columns in the WPD image is incremented by one. The number of columns in the WPD image is incremented by one until the remainder is equal to zero. At 516, the total size of the converted image in WPD format is equal to the number of columns in the WPD format times the number of rows in the WPD format times three.

Method 500 guarantees that the columns and rows of the imaginary 24-bit RGB image are less than or equal to the columns and rows of the original grayscale image respectively.

To print medical grayscale images with the driver, application developers convert the original grayscale image to WPD grayscale format that can be presented to Windows GDI functions as a 24-bit RGB color image. Next, the application calls GDI functions on this 24-bit color image. Finally, the application calls GDI StretchBlt to put the whole image on the page to be printed. The real source rectangle is specified in the WPD header. The StretchBlt function is used to send the medical grayscale image in WPD grayscale format for printing. The driver will intercept the StretchBlt calls for the special rendering on data in WPD grayscale format.

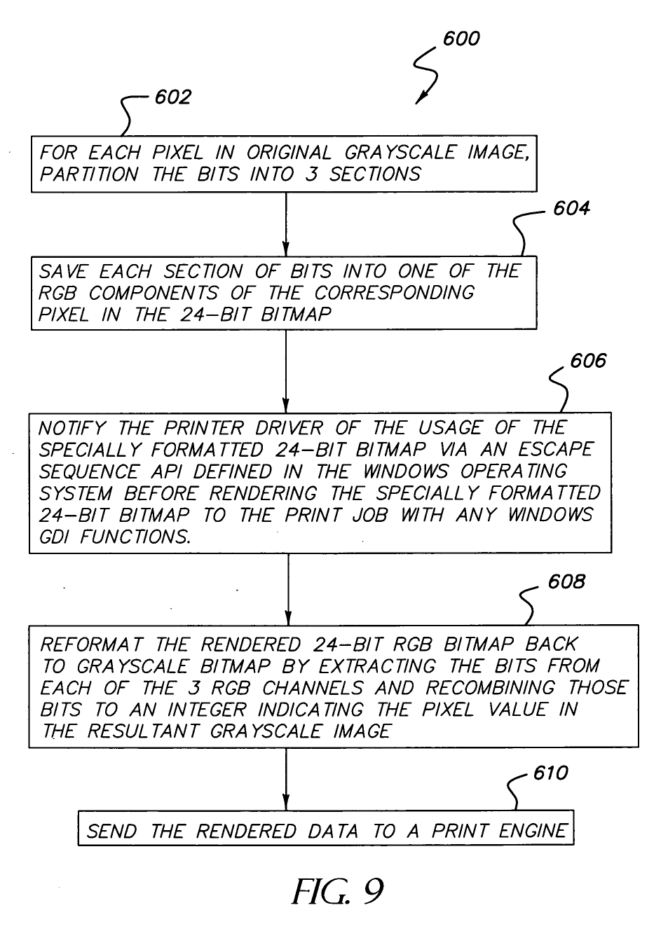

FIG. 9 is a flow diagram 600 illustrating another embodiment of a method for generating an imaginary 24-bit color image using grayscale data to pass through a Windows printing API. At 602, the bits for each pixel in the original grayscale image are partitioned into three sections. At 604, each section of bits is saved into one of the RGB components of the corresponding pixel in the 24-bit bitmap. At 606, the printer driver is notified of the usage of the specially formatted 24-bit bitmap via an escape sequence API defined in the Windows operating system before rendering the specially formatted 24-bit bitmap to the print job with any Windows GDI finctions. At 608, the rendered 24-bit bitmap is reformatted back to the grayscale bit map by extracting the bits from each of the three RGB channels and recombining those bits to an integer indicating the pixel value in the resultant grayscale image. At 610, the rendered data is sent to a print engine.

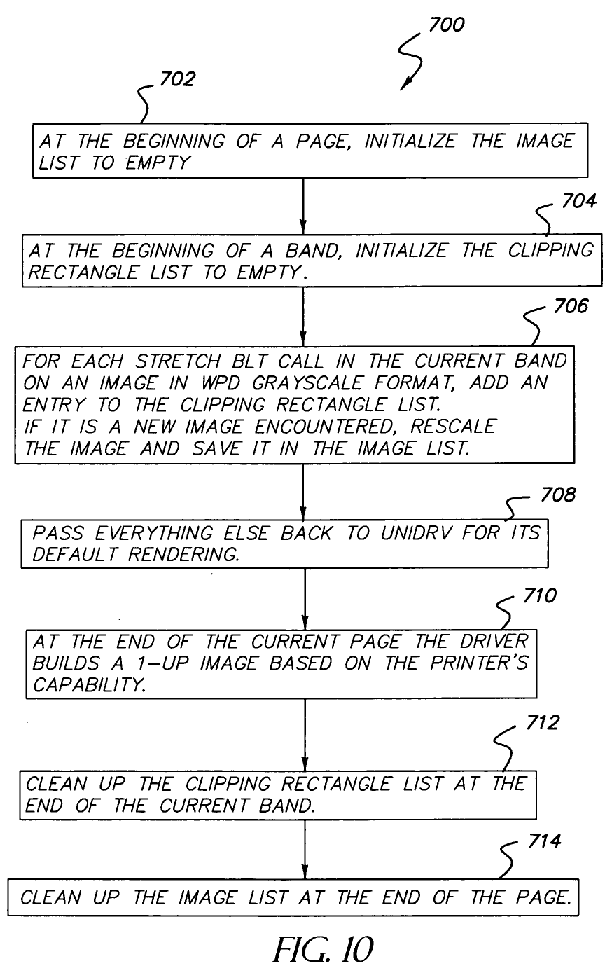

Rescaling of an image in cubic or bilinear magnification types will cause problems in banding mode rendering. To resolve this problem, the driver rescales the whole image at once and saves it aside when it is encountered by the driver the first time. Then different portions of the rescaled data are used in successive bands in the page. The driver uses an image list to keep the rescaled data for each of the grayscale images in WPD grayscale format on the page. The data is saved with information of bits allocated, bits used, and data space for further rendering later. An image on the list is identified by the destination rectangle on the final surface that it is rescaled into. The image list is initialized at the beginning of a page and cleaned up at the end of the page. The driver also maintains a list of clipping rectangles for the rendered data on the current band. The clipping rectangle on the list is also identified by the destination rectangle on the final surface to which it belongs. The driver allows a clipping rectangle to reference back to an entry in the image list. The clipping rectangle represents the overlapped area between the destination rectangle and the current band. The detailed rendering of a page in the banding mode is illustrated in FIG. 10.

FIG. 10 is a flow diagram 700 illustrating one embodiment of the detailed rendering of a page in a banding mode. At 702, at the beginning of a page the image list is initialized to empty. At 704, at the beginning of a band, the clipping rectangle list is initialized to empty. At 706, for each StretchBlt call in the current band on an image in WPD grayscale format, an entry is added to the clipping rectangle list. If a new image is encountered, the image is rescaled and saved in the image list. At 708, everything else is passed back to wUnidrv for its default rendering. Unidrv is a Microsoft based printing architecture for non-PostScript printers.

At 710, at the end of the current page, the driver builds a 1-up image based on the printer's capability. If the printer is a color printer, the driver further converts all saved images in the clipping rectangle list to color images and then merges them into the final surface to form the final color data stream. During the conversion, a grayscale image is first converted to luminance space and then optionally to 8-bits before finally to color. Otherwise, the driver converts the color final surface to grayscale format before merging the saved images into the final data stream after necessary conversion in bit depth and/or data space. During the conversion, the color surface is first converted to grayscale in luminance space and then to the application selected bit depth and data space. The color to grayscale conversion may be optimized out if the driver knows there is no color objects on the surface for the band. Now it is ready to send the final data stream to the DICOM SCU unit.

At 712, the clipping rectangle list is cleaned up at the end of the current band. Note that step 710 can occur after step 712.

At 714, the image list is cleaned up at the end of the page.

The use of destination rectangle as image ID disables the possibility of putting more than one image onto the same rectangle on the final surface. In addition, since the driver patches the data that was originally a WPD grayscale format onto the final surface after other normal objects on the final surface have been finalized, anything in rectangles for images that were originally in WPD grayscale format are wiped out.

Windows will potentially optimize out the StretchBlt callback into the driver rendering unit and directly put images on the final surface if source and destination rectangles are exactly the same. It is expected to be really rare to have the dimension of the converted color image match the destination rectangle because of the way of figuring out the dimension. If this does occur, the columns and rows can be reversed or the destination rectangle can be changed by reducing columns or rows by one pixel.

During image rendering, the driver needs to know the bit depth to which the data is to be rendered. For this purpose, the driver requires application developers to issue an ExtEscape command with the parameter of bpp:nn on the page where nn is 1-16, if there is at least one image in WPD grayscale format on the page. The default value is 8-bits used per pixel.

In one embodiment, in image rendering of replicate type, the driver can still render the data band by band to save memory. In another embodiment, as a last step in the image rendering for a band, if the target printer is grayscale, the final surface is converted to the final data stream in grayscale format before the saved images are merged into the stream. If there is no regular object on the final surface, the conversion can be avoided and the driver can directly put saved images in the final data stream. This may be achieved if the driver intercepts all GDI calls just to set a flag on the band to signify that. Application developers may also issue another ExtEscape command to signify if there is any regular object on the page.

A computer program product may include one or more storage medium, for example; magnetic storage media such as magnetic disk (such as a floppy disk) or magnetic tape; optical storage media such as optical disc, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

Embodiments of the present invention provide a Windows compatible DICOM print driver. The DICOM printer driver can print both medical images and medical data to a DICOM printer from Windows applications. The DICOM printer driver can print grayscale images up to 16-bits and also perform bilinear and cubic scaling, which are not possible with standard Windows drivers.

The invention has been described in detail with particular reference to certain preferred embodiments thereof, but it will be understood that variations and modifications can be effected within the spirit and scope of the invention.

### Parts List

100 Printing System
102 Modality Application
104 Proprietary Interface
106 Layout and Image Processing Module
108 Propriety Interface
110 DICOM Module
112 DICOM Protocol Communication Path
114 DICOM Printer
116 Computer Boundary
120 Printing System
122 Windows Printing API
124 Windows OS
126 Windows Printing API
128 Printing Architecture
130 DICOM Protocol Communication Path
132 Postscript Communication Path
134 Communication Path
136 Host Based Printer
138 Postscript Printer
200 Printing System
202 Application
204 Printer UI DLL
206 GDI
208 Spooler
210 Port Monitor
214 Printer
212 Printer Graphics DLL
220 Query DEVMODE
222 Send Print Commands
224 EMF File
226 Play Back
228 Rendering
230 Rendering Result
232 Rendered Print Job
234 Rendered Print Job
236 Communication Path
300 Print System
302 Application
304 Printer UI DLL
306 GDI
308 Spooler System
310 Print Processor
312 Printer Graphics DLL
314 EMF-to-DICOM Converter
316 DICOM Printer
320 Communication Path
322 DEVMODE Communication Path
324 Print Communication Path
326 EMF Communication Path
328 Rendering Communication Path
330 Communication Path
332 Bitmap plus DEVMODE Communication Path
334 Bitmap plus DEVMODE Communication Path
336 DICOM Protocol Communication Path
338 Computer Boundary
340 Printing System
342 Port Monitor
344 Dummy Medical Image Printer
400 WPD Header Structure
500 Process Flow Diagram
502-516 Process Procedures
600 Process Flow Diagram
602-610 Process Procedures
700 Process Flow Diagram
702-714 Process Procedures

What is claimed is:

1. A printing system comprising:
a windows printing subsystem including an Application Programming Interface (API); and
a printer driver configured to receive an image from the windows printing subsystem, render the image for printing, and send the rendered image to a Digital Imaging and Communications in Medicine (DICOM) printer for printing.

2. The system of claim 1, wherein the printer driver is configured to receive up to a 16-bit grayscale image through the windows printing subsystem.

3. The system of claim 2, wherein the printer driver is configured to receive an encoded image including a header, a grayscale pixel data stream, and padding bytes such that the printer driver can reconstruct the image and extract information from the header.

4. The system of claim 2, wherein the printer driver is configured to receive the 16-bit grayscale image encoded into a 24-bit RGB bitmap such that the printer driver can reconstruct the up to 16-bit grayscale image.

5. The system of claim 1, wherein the printer driver is configured to receive an image having pixel data in presentation value.

6. The system of claim 1, wherein the image includes 8-bit RGB data and greater than 8-bit grayscale data.

7. The system of claim 1, wherein the printer driver is configured to render each page of the image one at a time and send each page to the DICOM printer.

8. The system of claim 1, wherein the printer driver is configured to render the image in greater than 8-bit resolution.

9. The system of claim 1, wherein the image includes a digital image.

10. The system of claim 9, wherein the printer driver is configured to scale the digital image.

11. The system of claim 10, wherein the printer driver is configured to scale the digital image using one of cubic scaling and bilinear scaling.

12. The system of claim 1, wherein the printer driver is configured to send the image to a postscript printer.

13. The system of claim 1, wherein the printer driver is configured to send the image to a dummy printer.

14. A printing system comprising:
means for printing a document on a Digital Imaging and Communications in Medicine (DICOM) printer through a windows printing subsystem including an Application Programming Interface (API).

15. The system of claim 14, wherein the means for printing comprises means for rendering the document for printing on the DICOM printer.

16. The system of claim 15, wherein the means for rendering the document comprises means for rendering the document with up to 16-bit resolution.

17. The system of claim 14, wherein the document comprises a digital image and wherein the means for printing comprising means for scaling the digital image.

18. The system of claim 17, wherein the means for scaling the digital image comprises means for scaling the digital image using one of cubic scaling and bilinear scaling.

19. A method of printing a document comprising:
selecting a Digital Imaging and Communications in Medicine (DICOM) printer through a windows printing subsystem including an Application Programming Interface (API) for printing a document;
rendering the document for printing on the DICOM printer; and
sending the document to the DICOM printer for printing.

20. The method of claim 19, wherein rendering the document comprises rendering each page of the document one at a time; and
wherein sending the document comprises sending each rendered page to the DICOM printer one at a time.

21. The method of claim 19, wherein the document comprises a digital image, the method further comprising:
scaling the digital image.

22. The method of claim 21, wherein scaling the digital image comprises scaling the digital image using one of cubic scaling and bilinear scaling.

23. The method of claim 19, wherein rendering the document comprises rendering the document with greater than 8-bit resolution.
